(19) United States
(12) Patent Application Publication
(10) Pub. No.: US 2006/0060429 A1
(43) Pub. Date: Mar. 23, 2006

(54) Hose guide chock

(76) Inventor: Thomas Joseph Malinowski, Chapin, SC (US)

Correspondence Address: Thomas J. Malinowski, 11824 Broad River Rd., Chapin, SC, 29036, US

(21) Appl. No.: 10/943,863

(22) Filed: Sep. 20, 2004

(51) Int. Cl. B60T 3/00

(52) U.S. Cl. 188/32

(57) ABSTRACT

The invention provides a device, such as a block/chock for tires, that comprises a main body that generally conforms to the shape of an object that catches or binds a hose, wire, cable, and the like, and at least one movable or rotatable vertical tubular element. When placed adjacent the tire or other object that catches or binds the hose, etc., the device permits the hose, etc. to pass by the object without catching or binding.

### BACKGROUND OF THE INVENTION

1. Field of the Invention

The present invention relates to devices for guiding or protecting hoses, tubes, and the like from binding or crimping during movement around stationary objects. The device of the present invention has particular applicability in the automotive field, where various hoses, lines, etc. typically become stuck between one or more tires and the pavement or concrete that the automobile is sitting on as a mechanic, painter, or other person working on the automobile moves around it with a pneumatic or electric tool.

2. Description of Related Art

It is known that hoses, tubes, lines, cords, and the like can become caught or wedged between an object and the surface the object sits on during fabrication, repair, or maintenance of the object or other objects in the general area. For example, pneumatic hoses can become wedged in the nip between an automobile tire and the concrete pad on which the tire sits during repair or painting of an automobile. Likewise, an electrical cord can become wedged in the nip between an automobile tire and the concrete pad or pavement on which the tire sits. In addition, a garden hose can become wedged in the nip between a tire and a driveway during gardening, watering of a lawn, or washing a vehicle. Catching of the hose, etc. is an annoyance for the person using it, and causes a delay in completion of the job. Numerous devices to alleviate this problem have been devised.

For example, U.S. Pat. No. 4,895,225 discloses a cylindrical hose guide wheel chock that prevents a hose from being caught in a nip between a tire and the ground. The chock is a cylindrical wedge that fits between the tire and the ground. The chock fills in the nip between the tire and ground, and the cylindrical shape provides an outer surface that permits the hose to wrap around the tire without binding. However, the invention does not address the problem of friction between the hose and the chock, which can cause binding, resulting in the user having to dislodge the hose, as when no device is used.

In addition, U.S. Pat. No. 5,549,262 discloses a hose guide that consists of a one-piece spike and a roller that rotates around the spike. The spike of the hose guide is designed to be driven into the ground, while the roller is designed to guide a hose around an object, such as a flower bed or a car tire. While this invention appears to be suitable for guiding hoses around objects located on natural ground (yards, fields, etc.), it does not appear to be suitable for use in automotive shops or on other concrete or paved areas because the spike cannot be driven into the hard surfaces of concrete or pavement.

Further, U.S. Pat. No. 6,622,960 discloses a hose and cable guide for preventing hoses from being jammed under wheels. The device of that invention is comprised of a U-shaped wedge that fits between a tire and the ground on which the tire sits. Placement of the wedge in the nip between the tire and ground eliminates the nip where a hose could get caught. However, as with the device disclosed in U.S. Pat. No. 4,895,225, this device does not address the problem of binding of the hoses to the device by way of friction between the hose and device.

Thus, while numerous devices have been devised to alleviate binding of hoses, etc. at the nip between a tire and the ground, there is a need for a device that minimizes or eliminates binding while addressing the shortcomings of the prior art. Likewise, there is a need for a device that guides hoses, etc. around other objects in the shop or garage.

### SUMMARY OF THE INVENTION

The present invention provides a device and method for preventing hoses, lines, cords, cables, ropes, and the like from becoming caught in a nip area between a lower supporting surface (e.g., the ground, floor) and wheels, legs, or other objects in a work area that the hoses, etc. pass by, and in particular, around. In general, the device comprises a main body comprising at least one front surface that generally conforms to the shape of the wheel, leg, etc. that catches or otherwise binds the hose, etc.; at least one back surface; at least two side surfaces; at least one bottom surface; and at least one upper surface. The device further comprises at least one moveable, substantially vertical, generally tubular element, which can be attached to the main body at any position or multiplicity of positions on the main body. The movable, substantially vertical, generally tubular element rotates or otherwise turns on an axis, which permits the hose, etc. to pass by the main body, and thus the object the device is positioned adjacent to, without catching on the object or in the nip created by the object and the surface on which it is placed. That is, the vertical moveable tubular element(s) provides a contact surface for the hoses, etc. to be guided around the wheels, legs, etc. in the area where work is being done. In addition, the device allows the hoses, etc. to be pass by the object from various angles.

### BRIEF DESCRIPTION OF THE DRAWINGS

The accompanying drawings, which are incorporated in and constitute a part of the specification, illustrate several exemplary embodiments of the invention, and together with the written description, serve to explain the principles of the invention. The drawings are provided to better explain exemplary embodiments of the invention, and should not be considered as limiting the scope of the invention in any way.

FIG. 1 is a perspective view of one embodiment of the invention. In this embodiment, the device of the invention is designed for holding an automotive, truck, or airplane tire in place and permitting hoses, tubes, etc. to pass by the tire without binding.

FIG. 2 is a side view of the embodiment depicted in FIG. 1, positioned adjacent to a tire and guiding a hose around the tire.

FIG. 3 is a perspective view of an embodiment of the invention, in which the top plate for attaching the vertical tubular elements forms a top surface of the main body and the bottom surface is extended beyond the main body to form a bottom plate for attaching the vertical tubular elements.

FIG. 4 is a perspective view of an embodiment of the invention, in which the vertical tubular elements are positioned to extend beyond the planes of both the back surface and each respective side surface.

FIG. 5 is a perspective view of an embodiment of the invention, from the back of the device.

FIG. 6 is a side view of an embodiment of the invention, in which the vertical tubular elements are located outside the plane of the sides of the main body, and extend beyond the sides and back of the main body.

FIG. 7 is a perspective view of an embodiment of the invention, in which the vertical tubular element is formed in a generally hourglass shape.

FIG. 8 is a perspective view from the back of the device of an embodiment of the invention, in which upper horizontal tubular elements are provided in addition to the vertical tubular elements.

FIG. 9 is a perspective view of an embodiment of the device of the invention, in which two main bodies are joined by a tether and the two main bodies are placed in front and behind a tire.

FIG. 10 is a perspective view of an embodiment of the invention in which the device is designed to guide hoses, etc. around a 90° edge of a tool chest or other object.

### DETAILED DESCRIPTION OF EXEMPLARY EMBODIMENTS OF THE INVENTION

Reference will now be made in detail to various exemplary embodiments of the invention, some of which are illustrated in the accompanying drawings. Wherever possible, the same reference numbers are used throughout the drawings to refer to the same or like parts.

In a first aspect, the invention provides a device for preventing a hose, line, cord, cable, rope, and the like (hereinafter referred to as “hose, etc.”) from becoming caught on or bound by an object that the hose, etc. passes by or around. In embodiments, the device prevents a hose, etc. from becoming caught or bound in a nip area between a lower supporting surface and an object that rests on the supporting surface. In embodiments, the device is suitable for guiding a hose, etc. around an object or an area defined by an object and the surface that supports the object.

The object can be any object that a hose, etc. might be caught on or bound by. Examples include, but are not limited to, any object that is found in a work area, such as an automotive factory, an automotive repair shop, or an automotive paint shop; any object that is found in a furniture factory, furniture repair shop, or woodworking shop; and any object in a home garage or workshop. Specific objects include, but are not limited to, tires, casters or other wheels or rollers typically found on movable objects in work areas (industrial, commercial, or residential) or the home; legs, such as those of tables, benches, and chairs; chests, such as tool chests; and industrial equipment, such as hydraulic and pneumatic pumps, jacks, woodworking tools, and robots.

In general, the device comprises a main body comprising a bottom surface; at least one front surface that generally conforms to the shape of the object that catches or binds a hose, etc.; at least one back surface; at least two side surfaces; and a top surface. The device further comprises at least one moveable, substantially vertical, generally tubular element that is connected to the main body. This element is also referred to herein as a vertical tubular element. The vertical tubular element permits the hose, etc. to pass by the device, and thus an object the device is positioned adjacent to, without catching on or binding to the object, or binding in the nip created by the object and the surface on which it rests. That is, the vertical tubular element(s) provide a contact surface for the hose, etc. to be guided around the object. In addition, the vertical tubular element(s) allows the hose, etc. to be pass by the object from various angles without catching or binding.

As used herein, the terms device, block, and chock mean the same thing, and the terms are used interchangeably. Although in some exemplary embodiments, the front surface of the device is in the general shape of a tire (i.e., an arc, as would be seen in an automotive tire chock), and the device can be used to secure in place an automobile, airplane, or other moving vehicle having one or more tires, the device is not limited to such a shape or function, and thus is not limited to the typical function of a tire block or chock. Indeed, the device can have any number of three-dimensional shapes and numerous functions in addition to preventing binding of a hose, etc. in a nip between a tire and a surface supporting it.

The bottom surface of the main body of the device can be of any shape. Typically, the bottom surface conforms generally to the shape of the supporting surface that supports the object, in the vicinity of the object. Because the device is typically used to prevent binding of a hose, etc. between an object and the floor, street, or tarmac, or to guide the hose, etc. around an object on a flat surface, in embodiments, the bottom surface of the device is flat or substantially flat. With regard to the shape of the bottom surface relative to the object to be protected (i.e., the shape of the edge of the bottom surface that is to be placed adjacent to the object), the bottom surface can be, but is not necessarily, shaped to conform to the shape of the object, such that the device of the invention can be placed close to the object. For example, when the device is to be used to prevent catching or binding between a tire and a floor or pavement, the bottom surface at the edge to be placed adjacent the tire will have a generally flat shape, which conforms to the shape that the tire tread and floor or pavement create where they meet. As another example, when the device is to be used to prevent catching or binding between a lower edge or caster of a storage chest and a floor or pavement, the bottom surface at the edge to be placed adjacent the storage chest will form a 90° angle (or other appropriate angle), which conforms to the shape of the chest at the point where binding or catching occurs.

The bottom surface may include one or more protrusions or recesses, any of each of which can be the same size and shape, or individually differ in size and shape. In embodiments, protrusions in the form of spikes or short legs are provided as part of the bottom surface. These protrusions can be used to raise the main body of the device off of the supporting surface, to level the main body when it is to be used on supporting surfaces that are not flat, to secure the device from moving, or for any other reason. Alternatively, the protrusions can be round, such as in the form of wheels, casters, bearings, and the like. Such forms permit the device to be easily moved. For example, a device comprising a bottom surface comprising wheels can be easily moved into a desired position near an object that catches or binds a hose, etc. simply by rolling the device to the desired position. In embodiments, the protrusions are retractable, such that the device can be easily positioned at a desired place, then easily secured in place by retraction of the wheels, etc. Numerous ways to provide and attach wheels, rollers, etc. to a surface, including ways to provide and attach retractable wheels, rollers, etc., are known in the art, and any suitable way can be used. The number and location of protrusions are not critical to fabrication or use of the device, and the number, location, and combination of number and location can be selected by one of skill in the art to achieve a desired goal without undue experimentation. The bottom surface may also comprise one or more holes, divots or other indentations, or may comprise one or more protuberances, for securing one or more vertical tubular elements to the main body of the device.

The side surfaces can be of any shape. Typically, they are flat or somewhat rounded out away from the main body, such as rounded away from the center or the horizontal or vertical midline of the main body. The side surfaces connect the bottom, top, front, and back surfaces. Although not limited to such a texture, the side surfaces are typically smooth to permit passage of hoses, etc. around the device and object that binds or catches the hose, etc. Because the side surfaces connect the back and front surfaces, and connect the top and bottom surfaces, in embodiments where the front and back surfaces are joined to each other along a single edge or point, or the top and bottom surfaces are joined to each other along a single edge or point, one can consider the device to have no side surfaces or to have side surfaces that are defined by the edge or point created by the two joined surfaces. According to the present invention, characterization of the side surfaces in either way is equivalent, and the difference in description is merely a matter of semantics.

One or more side surfaces may include one or more protrusions or recesses. In embodiments, protrusions in the form of struts or legs are provided as part of one or more side surfaces. These protrusions can be used to raise the main body of the device off of the supporting surface, to level the main body when it is to be used on supporting surfaces that are not flat, to secure the device from moving, or for any other reason. Alternatively, the protrusions can be round or comprise an element that can roll, such as wheels, casters, bearings, and the like. Protrusions comprising elements capable of rolling permit the device to be easily moved, as is the case when such elements are provided as part of the bottom surface. In embodiments, the protrusions are retractable, either partially or wholly, into the main body, or otherwise capable of being raised to avoid contact with the supporting surface (e.g., the shop floor). Numerous ways to provide and attach protuberances, including those comprising wheels, rollers, etc. and those that are retractable, to a surface, are known in the art, and any suitable way can be used. The number and location of protrusions are not critical to fabrication or use of the device, and the number, location, and combination of number and location can be selected by one of skill in the art to achieve a desired goal without undue experimentation. One or more side surfaces may also comprise one or more holes, divots or other indentations, or may comprise one or more protuberances, for securing one or more vertical tubular elements to the main body of the device.

The back surface(s) can likewise be of any shape. Typically, the shape of the back surface conforms to the shape dictated by the front and side surfaces, or a shape that achieves the purpose of the particular design of the device. Typically, the back surface(s) is flat or somewhat rounded out away from the main body, such as rounded away from the center or the horizontal or vertical midline of the main body. The back surface(s) connects the bottom, top, and side surfaces, and can be of any texture. Because the back surface(s) connects the side surfaces, and connect the top surface to the bottom surface, in embodiments where the side surfaces are joined to each other along a single edge or point, or the top and bottom surfaces are joined to each other along a single edge or point, one can consider the device to have no back surface or to have a back surface that is defined by the edge or point created by the two joined surfaces. According to the present invention, characterization of the back surface in either way is equivalent, and the difference in description is merely a matter of semantics.

One or more back surfaces may include one or more protrusions or recesses. In embodiments, protrusions in the form of struts or legs are provided as part of one or more back surfaces. These protrusions can be used to raise the main body of the device off of the supporting surface, to level the main body when it is to be used on supporting surfaces that are not flat, to secure the device from moving, or for any other reason. Alternatively, the protrusions can be round or comprise an element that can roll, such as wheels, casters, bearings, and the like. Protrusions comprising elements capable of rolling permit the device to be easily moved, as is the case when such elements are provided as part of the bottom or side surfaces. In embodiments, the protrusions are retractable, either partially or wholly, into the main body, or otherwise capable of being raised to avoid contact with the supporting surface (e.g., the shop floor). Numerous ways to provide and attach protuberances, including those comprising wheels, rollers, etc. and those that are retractable, to a surface, are known in the art, and any suitable way can be used. The number and location of protrusions are not critical to fabrication or use of the device, and the number, location, and combination of number and location can be selected by one of skill in the art to achieve a desired goal without undue experimentation. One or more back surfaces may also comprise one or more holes, divots or other indentations, or may comprise one or more protuberances, for securing one or more vertical tubular elements to the main body of the device.

The top surface can also be of any shape. Typically, it is flat or somewhat rounded out away from the main body, such as rounded away from the center or the horizontal or vertical midline of the main body. The top surface connects the back, front, and side surfaces. Although not limited to such a texture, the side surfaces are typically smooth to permit passage of hoses, etc. around the device and object that binds or catches the hose, etc. Because the top surface connects the side surfaces, and connects the back surface to the front surface, in embodiments where the side surfaces are joined to each other along a single edge or point, or the front and back surfaces are joined to each other along a single edge or point, one can consider the device to have no top surface or to have a top surface that is defined by the edge or point formed by the two joined side surface(s). According to the present invention, characterization of the back surface in either way is equivalent, and the difference in description is merely a matter of semantics.

The top surface may include one or more protrusions or recesses. In embodiments, protrusions in the form of struts or legs are provided as part of one or more top surfaces. These protrusions can be used to raise the main body of the device off of the supporting surface, to level the main body when it is to be used on supporting surfaces that are not flat, to secure the device from moving, or for any other reason. Alternatively, the protrusions can be round or comprise an element that can roll, such as wheels, casters, bearings, and the like. Protrusions comprising elements capable of rolling permit the device to be easily moved, as is the case when such elements are provided as part of the bottom, side, or back surfaces. In embodiments, the protrusions are retractable, either partially or wholly, into the main body, or otherwise capable of being raised to avoid contact with the supporting surface (e.g., the shop floor). Numerous ways to provide and attach protuberances, including those comprising wheels, rollers, etc. and those that are retractable, to a surface, are known in the art, and any suitable way can be used. The number and location of protrusions are not critical to fabrication or use of the device, and the number, location, and combination of number and location can be selected by one of skill in the art to achieve a desired goal without undue experimentation. The top surface may also comprise one or more holes, divots or other indentations, or may comprise one or more protuberances, for securing one or more vertical tubular elements to the main body of the device.

The front surface(s) may be of any shape and texture. The front surface(s) connects the side surfaces and the top and bottom surfaces. It also provides a surface that permits the device to be placed in sufficient proximity to an object that binds or catches a hose, etc. for the device to be effective at guiding the hose etc. around the object. Typically, the front surface(s) is designed to permit the device to be placed in close proximity to an object that binds or catches a hose, etc., by itself or in conjunction with a supporting surface that the object sits on. For example, when the device is to be used as a wheel chock, the front surface will be formed in an arc to mimic the shape of the tire. As another example, when the device is to be used to guide hoses, etc. around a chest, table, bench, or other object having a substantially square edge, the device of the invention will have two front surfaces, which together form an internal 90° angle that mimics the shape of the edge of the chest, etc.

While not preferred, the front surface(s) may include one or more protrusions or recesses. In embodiments, protrusions in the form of struts or legs are provided as part of one or more front surfaces. These protrusions can be used to raise the main body of the device off of the supporting surface, to level the main body when it is to be used on supporting surfaces that are not flat, to secure the device from moving, or for any other reason. Alternatively, the protrusions can be round or comprise an element that can roll, such as wheels, casters, bearings, and the like. Protrusions comprising elements capable of rolling permit the device to be easily moved, as is the case when such elements are provided as part of the bottom, side, or back surfaces. In embodiments, the protrusions are retractable, either partially or wholly, into the main body, or otherwise capable of being raised to avoid contact with the supporting surface (e.g., the shop floor). Numerous ways to provide and attach protuberances, including those comprising wheels, rollers, etc. and those that are retractable, to a surface, are known in the art, and any suitable way can be used. The number and location of protrusions are not critical to fabrication or use of the device, and the number, location, and combination of number and location can be selected by one of skill in the art to achieve a desired goal without undue experimentation. The front surface(s) may also comprise one or more holes, divots or other indentations, or may comprise one or more protuberances, for securing one or more vertical tubular elements to the main body of the device.

The elements that make up the main body can be made from any material that is suitable for such devices. Non-limiting examples include metal, plastic, rubber, wood, fabric, paper products (e.g., cardboard); composites, and any combinations of two or more of such materials. One of skill in the art can select suitable materials without undue experimentation. Furthermore, the main body may be solid or hollow, and the surfaces comprising the main body can be of any suitable thicknesses.

The main body can be of any suitable size, the size typically being selected based on the object to be protected and the space typically available in the environment where the object is found. In general, the device is no bigger than necessary to stop a hose etc. from being caught or bound by an object or by the nip created by an object and the surface supporting the object. For example, when the device is designed as a tire chock, it can measure approximately 8″ wide by 8″ high by 8″ deep, having an arcuate front surface equating to the reverse angle of a normal vehicle wheel. Alternatively, when the device is designed to protect a tool chest, it can measure approximately 8″ wide by 8″ high by 8″ deep, or it can be approximately 8″ wide by 20″ high by 8″ deep. Other suitable combinations of width, height, and depth can be envisioned, and all are encompassed by the present invention. While any suitable dimensions and shapes are encompassed by the invention, it is preferred that dimensions be selected that provide a stable device (i.e., a device that is not prone to moving or falling away from the object when a hose, etc. is moved across the device). Selection of such dimensions is a simple engineering exercise that can be accomplished by those of skill in the art without undue experimentation.

The device comprises at least one vertical tubular element. The vertical tubular element(s) provides a surface for a hose, etc. to contact instead of a surface of an object that can catch or bind the hose, etc., or instead of a nip created by an object and a surface that supports it. While it is generally referred to as a “tubular” element, the vertical tubular element may take any number of shapes, as long as the shape permits rotation of the tubular element about its axis when in contact with a hose, etc. that is moving across the tubular element's surface, without dislodging the device from the area in which it is placed. For example, the vertical tubular element may have a cross-section that is round, hexagonal, octagonal, ovoid, or elliptical.

The at least one vertical tubular element is substantially vertical in that its axis of rotation is at an angle of at least 45° or more than 270° with respect to the bottom surface of the main body of the device. The device can comprise any number of vertical tubular elements, so long as the number is sufficient to guide a hose, etc. around an object that the device is placed adjacent to. In exemplary embodiments, the device comprises one or two vertical tubular elements.

The vertical tubular element(s) can be located at any position relative to the main body of the device. However, it is preferred that the vertical tubular element(s) be located at a position outside of the area of the main body, and along the back surface(s) or at or near the edge(s) where one or more back surface(s) meets one or more side surface(s). Non-limiting examples of positions where a vertical tubular element can be located are depicted in the Figures.

The vertical tubular elements can be of any height and width (e.g., diameter). However, it is preferred that the vertical tubular element be of a height that is approximately the height of the highest point of the back surface of the main body. It is also preferred that the vertical tubular element be sufficiently high to guide the hose, etc. around the object that the device is protecting. For example, if the main body is about 10″ wide, about 10″ high, and about 10″ deep, the vertical tubular element can be about 9.5″ high. Although the vertical tubular element may be of any width or diameter, it should be positioned such that its outer surface does not contact any other surfaces of the device that are mentioned above, thus permitting free rotation of the vertical tubular element when in contact with a hose, etc.

The vertical tubular elements are generally tubular. That is, a cross-section of the element taken along the width or diameter of the element will show a generally round, hexagonal, octagonal, elliptical, ovoid, etc. shape. However, the tubular element may have numerous shapes within this constraint. For example, the vertical element may be substantially tubular. It may also be in a generally hourglass shape. Likewise, it may be formed in one or more wave patterns, corkscrew patterns, or any other pattern that one of skill in the art might find suitable for guiding a hose, etc. around an object.

The vertical tubular element(s) may be made of any suitable material, including, but not limited to, metal, plastic, rubber, wood, fabric, paper products (e.g., cardboard); composites, and any combinations of two or more of such materials. One of skill in the art can select suitable materials without undue experimentation. Furthermore, the vertical tubular elements may be solid or hollow, and the surface of the elements may be of any texture.

The vertical tubular element(s) may be attached to the main body of the device by any means known to those of skill in the art, including, but not limited to, attachment by way of a bracket that is attached to the main body by a fastener. In preferred embodiments, the vertical tubular element(s) is attached to the main body by way of an upper plate and a lower plate, both of which being independently formed in a shape that permits attachment of the plate (and thus the tubular element) to the main body of the device. For example, the top and/or bottom plates may be flat or may be formed in a generally L shape to provide two surfaces at a 90° angle to each other, one for attaching the tubular element(s) and the other for attaching to the main body. In embodiments, the vertical tubular element(s) is attached to the upper plate by way of a connector, such as a pin, rod, or the like, and to the lower plate by way of a connector, such as a pin, rod, or the like. In embodiments, the vertical tubular element is fitted with one or two end caps that comprise the connector, the connector being attached to the end cap(s) by any suitable means, such as by creation of a unitary piece, welding or otherwise fusing the connector to the end cap, and with a nut that attaches to threads at the end of the connector that passes through the end cap surface into the interior of the tubular element. In embodiments, a single rod traverses the entire tubular element along its axis of rotation, and is attached to both the upper and lower plates. In such embodiments, the interior of the tubular element can be hollow (i.e., the surface of the tubular element is relatively thin and leaves an open area within the area defined by the surface of the tubular element of any diameter smaller than the outer diameter of the tubular element), and the rod can traverse an upper and lower end cap having holes in their respective centers, the tubular element being held in place along the length of the rod by any suitable means, such as by nuts fastened to the rod, cotter pins, or the like. In other embodiments, the tubular element is solid. In embodiments, the vertical tubular element is attached to either the top plate or the bottom plate, but not both. Indeed, in certain embodiments, only a single plate, either an upper plate or a lower plate is provided, and the vertical tubular element is attached to that plate. The connector can be securely fastened to one or both of the plates (e.g., by welding or gluing) or it can be fastened such that it freely rotates as the tubular element rotates (e.g., by way of a through rod held in place with a cotter pin, a spring type pin that engages a recess in the top and/or bottom plate, or the like). When the connector is securely fastened to the top or bottom plate (i.e., when it cannot rotate freely), the vertical tubular element is connected to the connector in any suitable way that permits the tubular element to rotate freely about its axis, such as, for example, through the use of bearings or simply by providing a through hole at the center point of the diameter of the tubular element that is larger than the diameter of the connector that passes through it. The connector, also may be semi-securely fastened to one or both of the plates, for example by simple friction, particularly when it is a through rod connector that is attached to both the top plate and bottom plate.

In embodiments, the top and bottom plates are connected to the main body at any suitable place, such as, but not limited to, one or more back surfaces, one or more side surfaces, the top surface, and/or the bottom surface. In preferred embodiments, the top plate is attached to the top surface and the bottom plate is attached to the bottom surface. Connection of the top and bottom plates can be accomplished by any suitable connector, including, but not limited to, adhesives, welding, screws, bolts and nuts, or simply friction. In other preferred embodiments, both the top plate and the bottom plate are attached to one or more back surfaces. In other embodiments, the vertical tubular element(s) is attached to the main body directly through the connector.

As can be seen, there are numerous ways to attach the vertical tubular element(s) to the main body, and numerous configurations of vertical tubular elements and main body. One of skill in the art may select any way and any configuration that achieve the purpose of guiding a hose, etc. around an object or around the nip created by the object and the surface supporting the object.

The device can comprise at least one substantially horizontal, generally tubular movable element (also referred to herein as a horizontal tubular element). By substantially horizontal, it is meant that the axis of rotation of this tubular element is at an angle of 45° or less or an angle of 270° or more with respect to the bottom surface of the main body of the device. In preferred embodiments, one or more horizontal tubular elements are attached to the top plate, the bottom plate, or both. The horizontal tubular element is provided to further guide a hose, etc. around an object. For example, although a chock comprising one or more vertical tubular elements according to the present invention might be sufficient to guide a hose, etc. around an automobile tire, it is possible that in certain circumstances (e.g., when an automotive painter must paint the roof of a van), the hose, etc. could rise above the height of the chock while the hose, etc. is being pulled past the chock. In such a situation, the hose, etc. might become bound on other objects, such as the suspension of the automobile. Inclusion of one or more horizontal tubular elements at one or more points along the top plate would block movement of the hose, etc. above the height of the chock, and thus would eliminate any problems that might occur if that were to happen. In an embodiment, the vertical tubular element and the horizontal tubular element are provided as a single element. In this embodiment, the tubular element is considered to be a vertical tubular element even though it has properties of the horizontal tubular element.

The horizontal tubular element(s) may be attached to the main body of the device by any means known to those of skill in the art, including, but not limited to, attachment by way of a bracket. In general, the horizontal tubular element(s) can comprise the same materials and elements, same configuration of elements, and be attached to the main body of the device in the same ways as disclosed for the vertical tubular elements, discussed above. In preferred embodiments, the horizontal tubular element(s) is attached to the main body by way of the upper plate and a lower plate described above. In these embodiments, the horizontal tubular element(s) is attached to the upper plate by way of a connector, such as a pin, rod, or the like, and to the lower plate by way of connector, such as a pin, rod, or the like. In embodiments, a single rod traverses the entire tubular element along its axis of rotation, and is attached to both the upper and lower plates. In other embodiments, the connector is attached to the top plate or the bottom plate, but not both. The connector can be securely fastened to one or both of the plates (e.g., by welding or gluing) or it can be fastened such that it freely rotates as the tubular element rotates (e.g., by way of a through rod held in place with a cotter pin or the like). It also may be semi-securely fastened to one or both of the plates, for example by simple friction.

As discussed above with respect to the vertical tubular element, the horizontal tubular element can be of any shape and size, and of any material, and have any texture. Examples of suitable shapes, sizes, materials, and textures include those disclosed above with regard to the vertical tubular element(s).

The device can further comprise at least one tether. The tether can be of any suitable material, shape, and design. Non-limiting examples include a cord, chain, and rope. The tether can be made of any material or combination of materials, such as, but not limited to, rubbers, fabrics, plastics, elastic materials (e.g., rubber bands, bungee cords), wood, and metals, or a combination of two or more of such materials. One of skill in the art can select suitable materials without undue experimentation.

The tether can be connected to any part of the main body, the upper or lower tubular element supports, or a combination of two or more of these. In embodiments, the tether is connected to two devices to form a single working unit. In such a configuration, the device of the invention can be placed on two different sides of an object (such as in front and behind a tire), or can be placed side-by-side to effectively provide a wider front surface area for protecting an object (for example, two relatively narrow devices can be placed side-by-side to hold and protect a relatively wide tire, such as an airplane tire or an earth-moving truck tire). Linking of two devices to form a single working unit can provide added protection for the object, can better secure the object from moving, and can guide hoses, etc. around multiple sides of an object at the same time. In embodiments, more than one tether is provided, connected to one or more surfaces or supports of the device.

A non-limiting exemplary description of a chock according to the present invention, and its method of fabrication is now presented to more fully describe the invention. It is to be understood that the following description is of a single embodiment of the invention, and should not be construed as a limitation on any aspect of the invention.

The approximate overall size of this exemplary block is 8″ wide by 8″ high by 8″ deep, but it can be made larger for use with bigger objects. A flat piece of material 1″ wide is attached to the top and bottom of the main body of the block/chock and extends beyond either side approximately 2″. Attached to the flat top and bottom surfaces of the main body, by way of a flat material that extends beyond the vertical plane of either or both sides of the block/chock main body (i.e., top and bottom plates) is a tubular piece of material approximately 1″ in diameter and 8″ high with a pin/rod affixed in the center for use in connecting this tubular piece to the top and bottom plates.

The main body of the block/chock measures approximately 8″ wide by 8″ high by 8″ deep. The base or bottom has a flat surface, and the block/chock has an arcuate front surface equating to the reverse angle of a normal vehicle wheel. One inch wide pieces of material 12″ long are attached to the top and bottom of the block/chock to form top and bottom plates. A 1″ tubular piece of material with an end cap at both ends is inserted between the top and bottom plates at a distance of ¾″ clearance from the main body of the block/chock. A pin/rod is placed in a center hole in the end cap and held in place by a keeper washer that will fit into a grooved end on the pin/rod.

The vertical tubular elements on either side of the device allow hoses, cables, etc. to move virtually effortlessly while not dislodging the device from it's location at the wheel, leg, etc. The device will allow work to be conducted with the use of hoses, cables, ropes and the like without them becoming caught in the wheel area while moving around the vehicle. The device will also double as a wheel chock to prevent movement of the vehicle. The device can also be manufactured in a larger size in order to be used successfully by fire departments with fire hoses. This would present an added safety feature during the daily work of these public servants.

In a second aspect, the invention provides a method of preventing a hose, etc. from becoming caught on or bound by an object that the hose, etc. passes by or around. In embodiments, the method prevents a hose, etc. from becoming bound or caught in a nip area between a lower supporting surface and an object. In embodiments, the method guides a hose, etc. around an area defined by an object and the surface that supports the object. The method generally comprises providing a device of the present invention and placing the device near an object that catches or binds the hose, etc.

The device and method of the invention were developed by the inventor upon recognizing, after having worked in the automotive paint and repair business for over ten years, that there is continually a need to drag hoses, cords, cables, and other similar items around vehicles being worked on, and that many times those items would become caught under the wheels of the vehicle or under/around legs of tables or other equipment or stands. The present invention addresses that problem, and provides a solution for it.

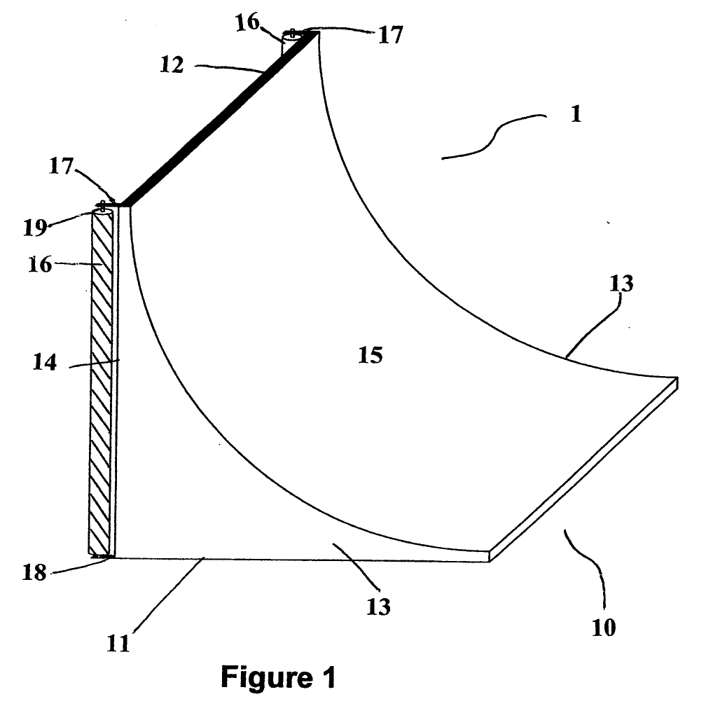

Turning now to the figures, FIG. 1 depicts one embodiment of the device of the present invention. The Figure shows a basic block/chock 1 comprising a main body 10 with a flat base having a bottom surface 11, a top surface 12, two side surfaces 13, a back surface 14, and an arcuate or curved contact front surface 15 for contact with a wheel. Two vertical tubular elements 16 are attached to the top surface by way of two top plates 17. The vertical tubular elements 16 are attached to the bottom surface 11 by way of two bottom plates 18. The vertical tubular elements 16 are connected to the top plates and bottom plates through a single connector 19 per tubular element, which is a through rod running along the vertical axis of the vertical tubular elements, and which traverses the top plates by way of holes in the top plates that accommodate the connectors. The vertical tubular elements are positioned to extend beyond the planes of both the back surface and the side surfaces.

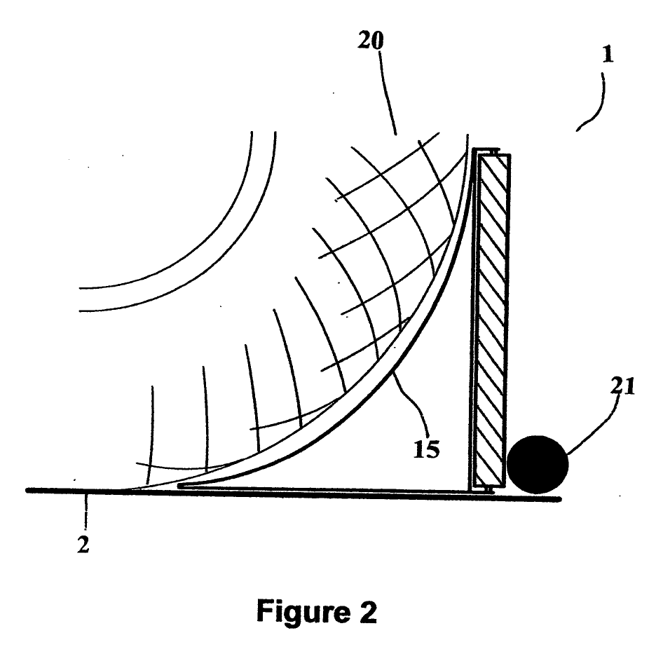

FIG. 2 shows a chock/block 1 according to the invention, positioned adjacent an automotive tire. The front surface 15 of the chock/block is curved to accommodate the shape of the tire. The figure depicts the device 1 guiding a hose around the tire, thus avoiding binding of the hose in the nip formed by the tire 20 and the surface supporting it 2.

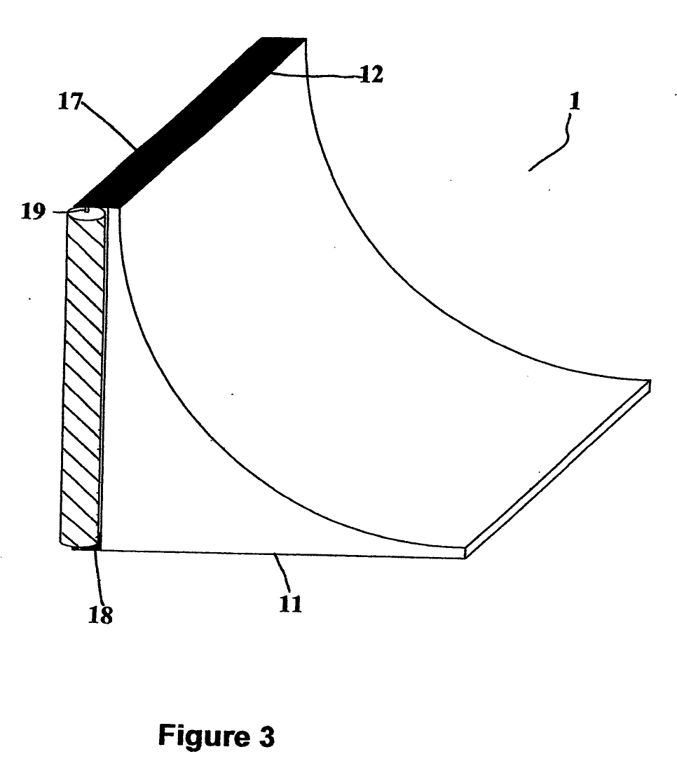

FIG. 3 depicts a chock/block 1 according to the invention, in which a single top plate 17 and a single bottom plate 18 is provided. The vertical tubular elements are connected to the top and bottom plates by way of a connector 19, which does not pass through the top plate 17 or the bottom plate 18. The top plate 17 is integral with the top surface 12, and thus forms a single element. The bottom plate 18 is integral with the bottom surface 11, and thus forms a single element.

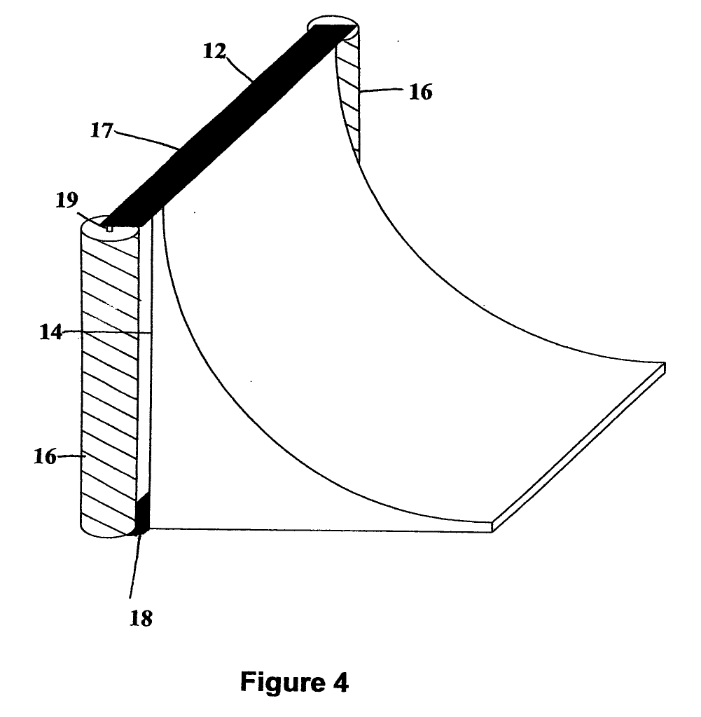

FIG. 4 depicts an embodiment of the device of the invention, in which the vertical tubular elements 16 are positioned on the top plate 17 and bottom plate 18 to extend beyond the planes of both the back surface and each respective side surface. In this Figure, a single top plate 17 and a single bottom plate 18 is provided. The vertical tubular elements are connected to the top and bottom plates by way of a connector 19, which does not pass through either the top plate 17 or bottom plate 18. The top plate 17 is integral with the top surface 12, and thus forms a single element. The bottom plate 18 is connected to the back surface 14 with screws (not depicted).

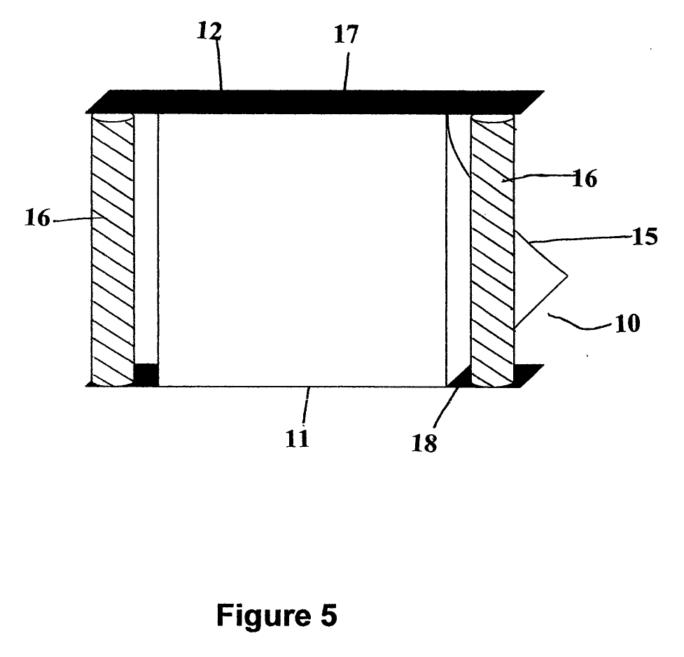

FIG. 5 depicts an embodiment of the invention, in which two vertical tubular elements 16 are provided. The vertical tubular elements 16 are attached to a top plate 17 and bottom plate 18. The top plate 17 is integral with the top surface 12, and thus forms a single element. The bottom plate 18 is attached to the bottom surface 11 by way of a weld. As shown in the Figure, the bottom plate 18 and top plate 17 are off-set. That is, the top plate 17 extends beyond the main body 10 toward the back, while the bottom plate 18 is flush with the back surface 14 of the main body 10. This configuration results in the vertical tubular elements 16 being angled, permitting the tubular elements to avoid the plane of the front surface 15.

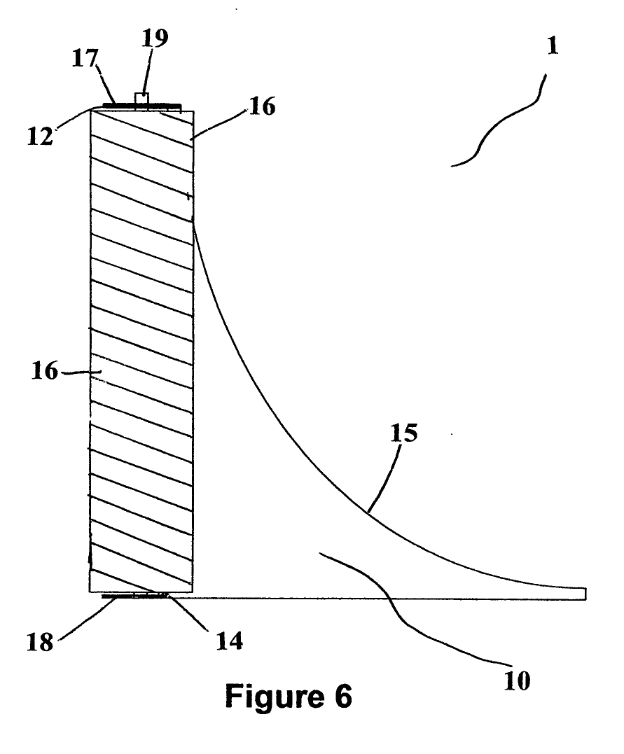

FIG. 6 depicts a chock/block 1 in which vertical tubular elements 16 have a diameter that is greater than the width of the top plate 17 or bottom plate 18, and extend beyond the planes of both the front surface 15 and back surface 14 of the main body 10. In this Figure, the vertical tubular elements 16 are attached to the bottom plate 18 and top plate 17 by a through rod connector 19 that traverses a through hole in the top plate 17 but does not traverse the bottom plate. The top plate 17 is integral with the top surface 12 and thus forms a single element. The bottom plate 18 is connected to the back surface 14 by a fastener.

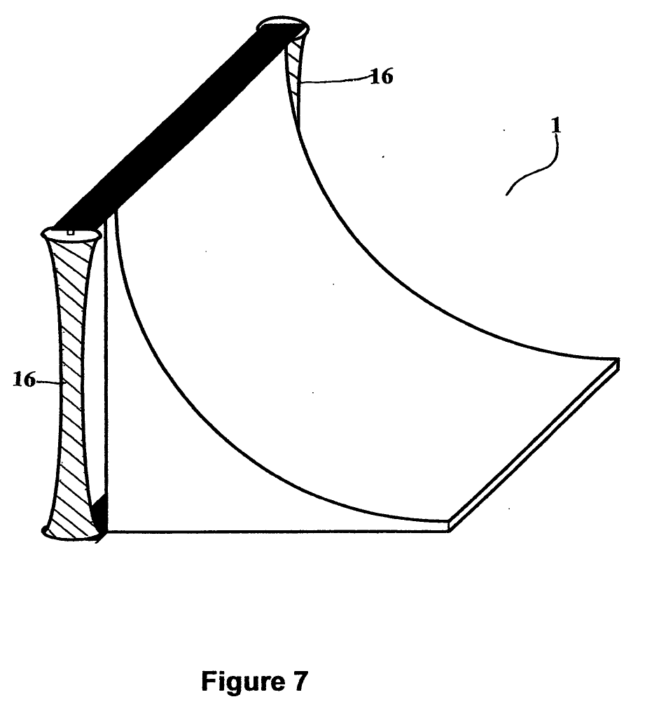

FIG. 7 depicts a device 1 according to the invention in which the vertical tubular elements 16 have a generally hourglass shape. Shaping the tubular elements 16 in this way aids in retaining the hose, etc. on the tubular elements 16 as the hose passes by the device by guiding the hose, etc. toward the center of the tubular elements 16. A more pronounced hourglass shape may be used in embodiments to enhance this effect.

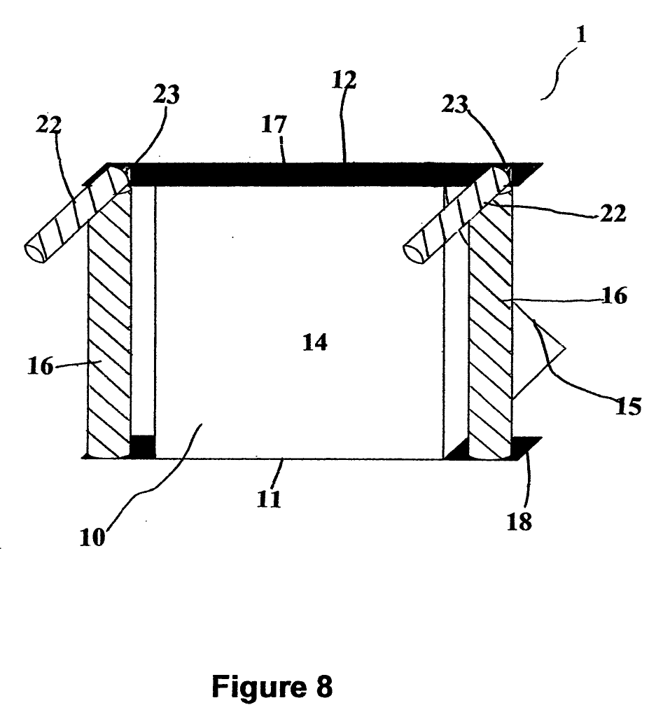

FIG. 8 depicts a device 1 in which two horizontal tubular elements 22 are connected to the top plate 17 by way of a single connector 23 each.

As in FIG. 5, the vertical tubular elements 16 are attached to a top plate 17 and bottom plate 18. The top plate 17 is integral with the top surface 12, and thus forms a single element. The bottom plate 18 is attached to the bottom surface 11 by way of a weld. As shown in the Figure, the bottom plate 18 and top plate 17 are off-set. That is, the top plate 17 extends beyond the main body 10 toward the back, while the bottom plate 18 is flush with the back surface 14 of the main body 10. This configuration results in the vertical tubular elements 16 being angled, permitting the tubular elements to avoid the plane of the front surface 15.

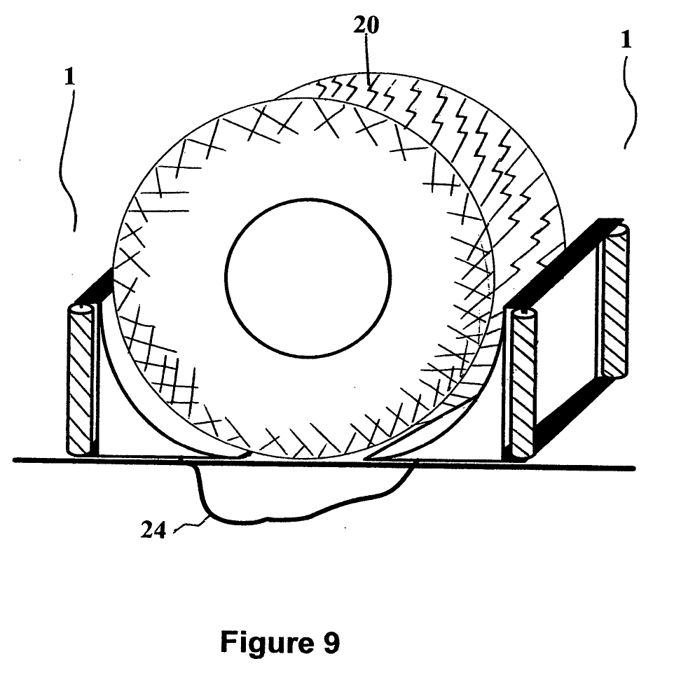

FIG. 9 depicts two devices 1 joined by a tether 24, where the two devices are placed in front and behind a tire 20. In this configuration, the devices work as a single unit to not only prevent hoses, etc. from binding in the nip created in front and behind a tire resting on a surface, but also secure the tire from moving, and thus also secure the automobile, airplane, etc. that the tire is attached to.

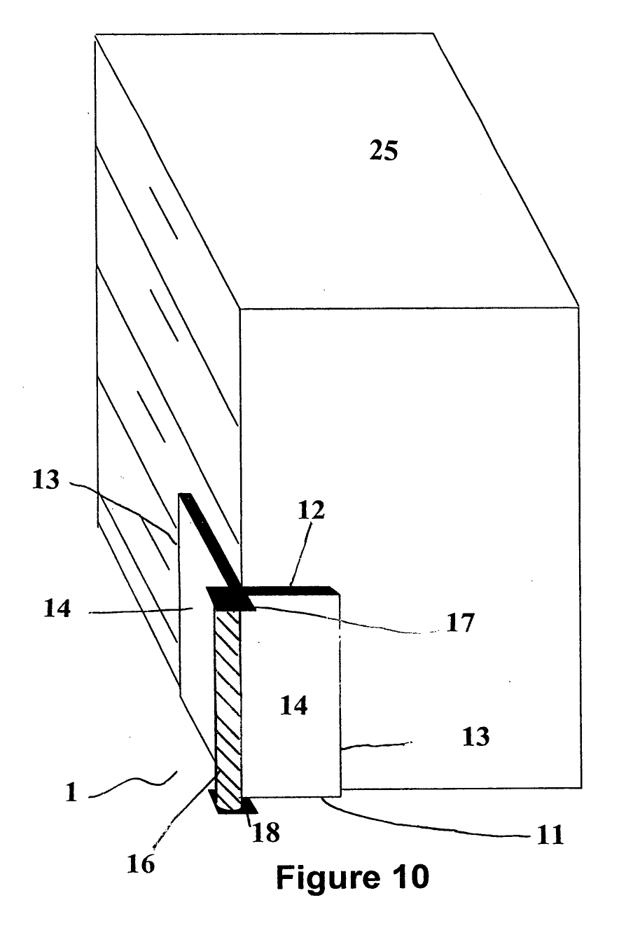

FIG. 10 depicts an embodiment of the invention in which the device 1 is placed adjacent a tool chest 25. The device comprises two front surfaces 15 that face the tool chest. It also comprises two side surfaces 13, a top surface 12, two back surfaces 14, and a bottom surface 11. A single vertical tubular element 16 is attached to the main body by way of a top plate 17 and a bottom plate 18, which are connected to the main body 10 at the top surface 12 and bottom surface 11, respectively.

It will be apparent to those skilled in the art that various modifications and variations can be made in the practice of the present invention and in construction of this device without departing from the scope or spirit of the invention. Other embodiments of the invention will be apparent to those skilled in the art from consideration of the specification and practice of the invention. It is intended that the specification and Figures be considered as exemplary only, with a true scope and spirit of the invention being indicated by the following claims.

What is claimed is:

1. A device comprising:
a main body comprising at least one front surface, at least one back surface, at least one side surface, a top surface, and a bottom surface, wherein the at least one front surface is formed to generally conform to the shape of a portion of an object that catches or binds a hose, cord, line, cable, and the like, and
at least one substantially vertical, generally tubular element attached to the main body such that, when the device is positioned adjacent an object, the device prevents the object from catching or binding a hose, cord, line, cable, and the like when the hose, cord, line, cable, and the like is pulled across the object.

2. The device of claim 1, comprising two vertical tubular elements.

3. The device of claim 1, further comprising a top plate connected to the top surface or the back surface, and a bottom plate connected to the bottom surface or the back surface.

4. The device of claim 1, wherein the front surface comprises an arc shape that generally conforms to the shape of an automobile or airplane tire.

5. The device of claim 1, further comprising
a top plate and a bottom plate, the top plate and bottom plate being attached to the top surface or bottom surface, respectively, or the back surface, of the main body by at least one fastener,
at least one connector that individually connects each of the at least one vertical tubular elements to the top plate and bottom plate.

6. The device of claim 5, wherein the connector is a through rod that traverses the vertical tubular element along its axis of rotation and connects the vertical tubular element to the top and bottom plates by traversing the top and bottom plates by way of a through hole in the top and bottom plates.

7. The device of claim 1, wherein the vertical tubular element is shaped in a generally hourglass shape.

8. The device of claim 1, further comprising at least one substantially horizontal, generally tubular element attached to the top plate, the bottom plate, or both.

9. The device of claim 1, further comprising a tether attached to the main body.

10. The device of claim 1, comprising two front surfaces formed to create an internal 90° angle to permit the device to be placed adjacent a tool chest or other object having a 90° edge.

11. A block/chock comprising
a main body comprising a flat bottom surface for contact with the ground and for attaching a bottom plate, a floor, pavement, or the like, and an arcuate or curved front surface for contact with a wheel, and a top surface for attaching a top plate, wherein the main body measures approximately 8″ wide by 8″ high by 8″ deep;
a top plate attached to the top surface, wherein the top plate is a flat plate approximately 1″ wide and 12″ long, and wherein the top plate overhangs the sides of the main body by about 2″ on each side;
a bottom plate attached to the bottom surface, wherein the bottom plate is a flat plate approximately 1″ wide and 12″ long, and wherein the bottom plate overhangs the sides of the main body by about 2″ on each side;
two substantially vertical, generally tubular elements for guiding a hose, line, cord, cable, and the like around an object, the vertical tubular elements comprising a hole at both ends at the center of the axis of rotation for receiving a connector, the vertical tubular elements attached at the bottom to the bottom plate and at the top to the top plate, wherein the vertical tubular elements are approximately 1″ in diameter and approximately 8″ high, each of the tubular elements being attached to the top and bottom plates at a position that provides approximately ¾″ clearance between the vertical elements and the main body of the device;
one connector for each tubular element, the connectors traversing the vertical tubular elements along the center axis of rotation of the tubular element and having a grooved end, the connector comprising a keeper washer that fits into the grooved end to secure the connector to the top and bottom plates.

12. The device of claim 11, wherein the connector is a pin or rod.
